(19) United States
(12) Patent Application Publication
(10) Pub. No.: US 2012/0288157 A1
(43) Pub. Date: Nov. 15, 2012

(54) IMAGE PROCESSING APPARATUS, IMAGE PROCESSING METHOD, AND IMAGE PROCESSING PROGRAM

(75) Inventor: Koichiro Kishima, Kanagawa (JP)

(73) Assignee: SONY CORPORATION, Tokyo (JP)

(21) Appl. No.: 13/460,319

(22) Filed: Apr. 30, 2012

(30) Foreign Application Priority Data
May 13, 2011 (JP) 2011-107851

(51) Int. Cl. G06T 5/00; G06K 9/62

(52) U.S. Cl. 382/106

(57) ABSTRACT

An image processing apparatus includes: a depth calculation portion configured to calculate, based on a first blurred image of an observation area of at least a part of a sample, that is obtained by relatively moving an objective lens of a microscope and the sample along an optical-axis direction of the objective lens and a second blurred image of the observation area that is obtained by relatively moving the objective lens and the sample along a direction that includes a component of the optical-axis direction but is different from the optical-axis direction, a depth of a bright spot in the sample in the optical-axis direction, the bright spot being obtained by coloring a target included in the observation area; and a correction portion configured to correct the first blurred image based on information on the calculated depth of the bright spot.

### CROSS REFERENCES TO RELATED APPLICATIONS

The present application claims priority to Japanese Priority Patent Application JP 2011-107851 filed in the Japan Patent Office on May 13, 2011, the entire content of which is hereby incorporated by reference.

### BACKGROUND

The present disclosure relates to an image processing apparatus, an image processing method, and an image processing program for processing an image obtained using a microscope.

In a field of pathology and the like, there is fluorescent staining as a method used for observing a biological tissue. Fluorescent staining is a method of staining a sample by a stain in advance and observing fluorescence emitted from the stain that has been excited by being irradiated with excitation light using a fluorescent microscope. By selecting an appropriate stain, a specific tissue for which the stain has a chemical specificity (e.g., subcellular organelle) can be observed. One type of a stain may be used in some cases, but by using a plurality of types of stains that have different chemical specificities and fluorescent colors, a plurality of tissues can be observed with different fluorescent colors.

For example, polymers such as a DNA and an RNA included in a cell nucleus are stained by a specific stain, and the polymers emit fluorescence as bright spots in an image obtained by a fluorescent microscope (fluorescent image). Such a state of the bright spots (number, position, size, etc.) mainly becomes a pathological analysis target.

For example, a “microorganism measurement apparatus” disclosed in Japanese Patent Application Laid-open No. 2009-37250 includes a spectroscopic filter that disperses fluorescence emitted from a sample and obtains a fluorescent image for each of predetermined colors using a monochrome imager. Since a bright spot included in the fluorescent image is limited to a transparent wavelength of the spectroscopic filter, a bright spot can be counted for each color even when a plurality of stains are used (see, for example, Japanese Patent Application Laid-open No. 2009-37250).

### SUMMARY

In an image processing system of the past that uses a microscope, a handled data amount has been massive.

In view of the circumstances as described above, there is a need for an image processing apparatus, an image processing method, and an image processing program that are capable of reducing a data amount.

According to an embodiment of the present disclosure, there is provided an image processing apparatus including a depth calculation portion and a correction portion.

The depth calculation portion is configured to calculate, based on a first blurred image of an observation area of at least a part of a sample, that is obtained by relatively moving an objective lens of a microscope and the sample along an optical-axis direction of the objective lens and a second blurred image of the observation area that is obtained by relatively moving the objective lens and the sample along a direction that includes a component of the optical-axis direction but is different from the optical-axis direction, a depth of a bright spot in the sample in the optical-axis direction, the bright spot being obtained by coloring a target included in the observation area.

The correction portion is configured to correct the first blurred image based on information on the calculated depth of the bright spot.

Since the depth calculation portion calculates the depth of the bright spot in the observation area of the sample based on the first and second blurred images, a data amount can be reduced.

A blur degree of a bright spot in an image obtained by the microscope changes according to a depth of a sample in the optical-axis direction at which the bright spot is positioned, that is, the depth of the bright spot, so the correction portion corrects the first blurred image based on the information on the calculated depth of the bright spot in the sample. As a result, a luminance of the bright spot can be quantified.

The correction portion may correct a luminance of the bright spot using a depth correction parameter set for each unit depth in the optical-axis direction. The correction portion can easily execute a luminance correction operation by using the depth correction parameter.

The image processing apparatus may further include a wavelength calculation portion configured to calculate a wavelength range of light at the bright spot. In this case, the correction portion further corrects the luminance of the bright spot based on the depth correction parameter and information on the calculated wavelength range. With this structure, it becomes possible to compensate for a difference in focal depths of the objective lens due to a color of the bright spot (wavelength).

For example, the correction portion may correct a luminance of the bright spot using a shaping correction parameter set according to a distance from a position of a peak value of the luminance of the bright spot in a plane of the first blurred image. With this structure, the blur of the bright spot in the first blurred image can be corrected.

The image processing apparatus may further include a 3D image generation portion configured to generate a 3D image of the observation area including the target based on information on a luminance of the bright spot corrected by the correction portion and information on the depth of the bright spot calculated by the depth calculation portion. With this structure, 3D display in the observation area becomes possible.

The image processing apparatus may further include another correction portion configured to correct a blurred image of another target in the first blurred image. The another target includes the target, is thicker than the target in the optical-axis direction, and continuously exists in the sample across an entire relative movement range of the objective lens and the sample in the optical-axis direction.

According to an embodiment of the present disclosure, there is provided an image processing method including calculating, based on a first blurred image of an observation area of at least a part of a sample, that is obtained by relatively moving an objective lens of a microscope and the sample along an optical-axis direction of the objective lens and a second blurred image of the observation area that is obtained by relatively moving the objective lens and the sample along a direction that includes a component of the optical-axis direction but is different from the optical-axis direction, a depth of the sample in the optical-axis direction at a bright spot obtained by coloring a target included in the observation area.

The first blurred image is corrected based on information on the calculated depth of the bright spot.

An image processing program according to an embodiment of the present disclosure causes a computer to execute the steps of the image processing method described above.

As described above, according to the embodiments of the present disclosure, a data amount can be reduced.

Additional features and advantages are described herein, and will be apparent from the following Detailed Description and the figures.

### BRIEF DESCRIPTION OF THE FIGURES

FIG. 1 is a diagram showing an image processing system according to an embodiment of the present disclosure;

FIG. 2 is a diagram showing a sample mounted on a stage from a side-surface direction of the stage;

FIG. 3 is a block diagram showing a structure of an image processing apparatus;

FIG. 4 is a diagram showing an example of an emission spectrum by each stain;

FIG. 5 is a diagram showing an example of a transmission spectrum of an emission filter;

FIG. 6 shows data of RGB luminance values of the emission spectrum for each color;

FIG. 7 is a flowchart showing processing of the image processing apparatus;

FIG. 8 is a diagram showing a scanning state of a focal point in a Z direction;

FIG. 9 is a diagram showing an image of a sample obtained by carrying out exposure processing while the focal point is moving in the Z direction (first image);

FIG. 10 is a diagram showing a scanning state of the focal point in the Z and X directions;

FIG. 11 is a diagram showing an image of a sample obtained by carrying out exposure processing while the focal point is moving in the Z and X directions (second image);

FIG. 12 is a diagram showing a synthetic image in which the first and second images are synthesized;

FIG. 13 is a diagram showing calculation processing for a depth position of a target using the synthetic image shown in FIG. 12;

FIG. 14 is a diagram for explaining that a luminance of a bright spot differs for each unit depth;

FIG. 15A is a diagram showing results obtained by correcting a blur of a bright point of each marker in a graph each indicated by black dots using a correction profile including a luminance correction coefficient and a shaping correction coefficient (FIG. 15B);

FIG. 16 shows an example of list data of a focused image;

FIG. 17 is a diagram for explaining a method of generating 3D image data;

FIG. 18 is a flowchart showing correction processing for a blurred image of a target according to another embodiment of the present disclosure; and

FIG. 19 is a diagram for explaining the correction processing shown in FIG. 18.

### DETAILED DESCRIPTION

Hereinafter, embodiments of the present disclosure will be described with reference to the drawings.

### [Structure of Image Processing System]

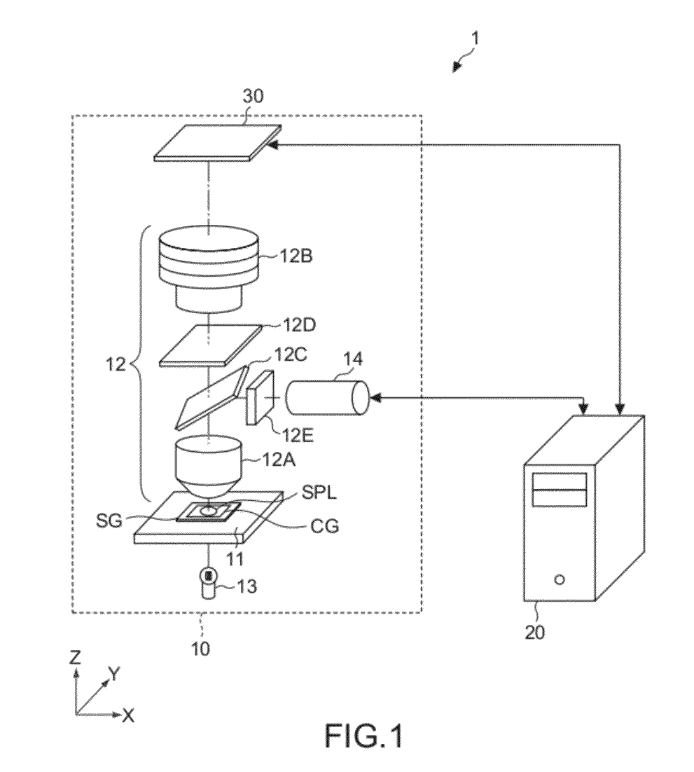

FIG. 1 is a diagram showing an image processing system 1 according to an embodiment of the present disclosure. As shown in the figure, the image processing system 1 of this embodiment includes a microscope (fluorescent microscope) 10 and an image processing apparatus 20 connected to the microscope 10.

The microscope 10 includes a stage 11, an optical system 12, a bright-field photographing panel lamp 13, a light source 14, and an image pickup device 30.

The stage 11 includes a mounting surface on which a sample SPL of a biological polymer such as a tissue section, a cell, and a chromosome can be mounted and is movable in directions parallel and vertical to the mounting surface (XYZ-axis directions).

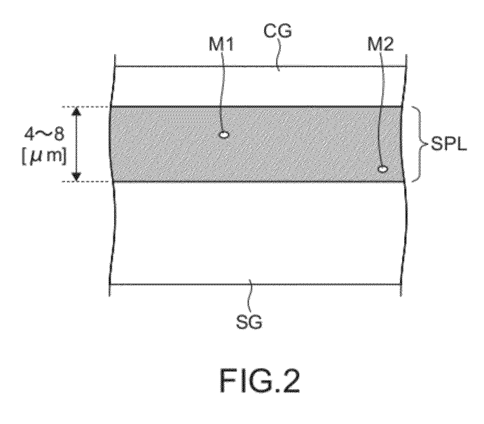

FIG. 2 is a diagram showing the sample SPL mounted on the stage 11 from a side-surface direction of the stage 11.

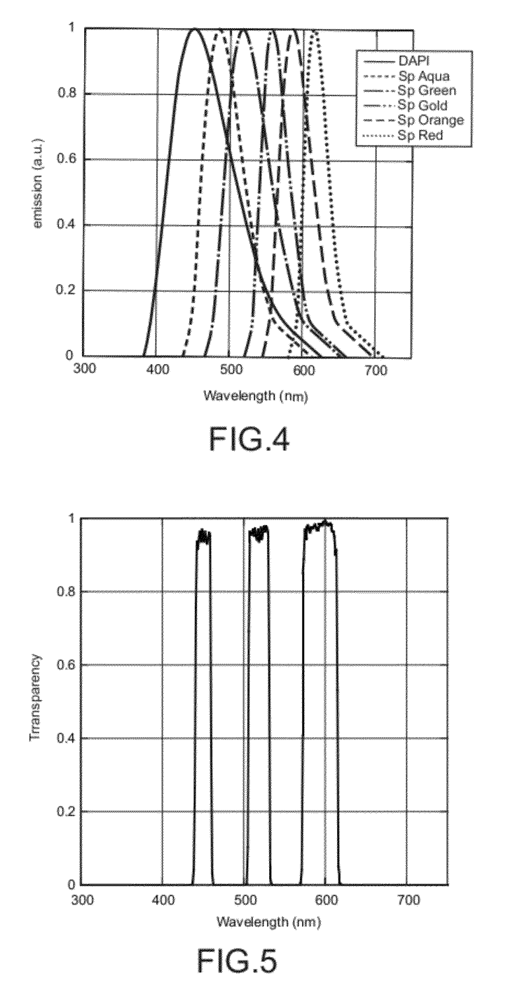

As shown in the figure, the sample SPL has a thickness (depth) of about 4 to 8 nm in the Z direction and is fixed between a slide glass SG and a cover glass CG by a predetermined fixing method, and an observation object in the sample SPL is stained as necessary. A stain is selected from a plurality of stains that emit different fluorescence by excitation light irradiated from one light source 14. FIG. 4 is a diagram showing an example of an emission spectrum by each stain. Fluorescent staining is carried out for marking a specific target in the sample SPL, for example. Targets subjected to fluorescent staining are represented as fluorescent markers M (M1, M2) in FIG. 2, and the fluorescent markers M are expressed as bright spots in an image obtained by the microscope.

Referring back to FIG. 1, the optical system 12 is provided above the stage 11 and includes an objective lens 12A, an imaging lens 12B, a dichroic mirror 12C, an emission filter 12D, and an excitation filter 12E.

The objective lens 12A and the imaging lens 12B enlarge an image of the sample SPL obtained by the bright-field photographing panel lamp 13 by a predetermined magnification and form an image of the enlarged image on an image pickup surface of the image pickup device 30. The enlarged image is an image of at least a partial area of the sample and an image as an observation area of the microscope 10. It should be noted that when observing an image of the sample SPL using the bright-field photographing panel lamp 13, an image observation with more-accurate color information can be carried out by removing the dichroic mirror 12C and the emission filter 12D from an optical path.

The excitation filter 12E generates excitation light by causing only light having an excitation wavelength for exciting a fluorescent pigment to transmit therethrough out of light emitted from the light source 14. The dichroic mirror 12C reflects the excitation light that is transmitted through the excitation filter and enters the dichroic mirror 12C and guides it to the objective lens 12A. The objective lens 12A collects the excitation light at the sample SPL.

When fluorescent staining is carried out on the sample SPL fixed to the slide glass SG, a fluorescent pigment is emitted by the excitation light. Light obtained by such a light emission (color light) is transmitted through the dichroic mirror 12C via the objective lens 12A and reaches the imaging lens 12B via the emission filter 12D.

The emission filter 12D absorbs light other than the color light enlarged by the objective lens 12A (outside light). An image of the color light from which outside light has been removed by the emission filter 12D is enlarged by the imaging lens 12B and imaged on the image pickup device 30 as described above.

FIG. 5 is a diagram showing an example of a transmission spectrum of the emission filter 12D. The emission spectrum for each color by fluorescent staining shown in FIG. 4 is filtered by the emission filter 12D and additionally filtered by RGB (Red, Green, Blue) color filters of the image pickup device 30 to be described later.

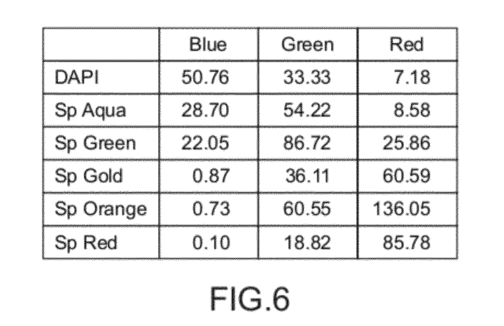

FIG. 6 shows data of RGB luminance values of the emission spectrum for each color generated as described above, that is, data indicating a ratio of RGB luminance values in a case where light emitted by fluorescent pigments are absorbed by the RGB color filters of the image pickup device 30 and color signals are formed. The RGB luminance value data is stored in advance at a time of a factory shipment of the image processing apparatus 20 (or software installed in image processing apparatus 20). However, the image processing apparatus 20 may include a program for creating RGB luminance value data.

The bright-field photographing panel lamp 13 is provided below the stage 11 and irradiates illumination light onto the sample SPL mounted on the mounting surface via an opening (not shown) formed on the stage 11.

Examples of the image pickup device 30 include a CCD (Charge Coupled Device) and a CMOS (Complementary Metal Oxide Semiconductor). The image pickup device 30 is a device that includes the RGB color filters as described above and is a color imager that outputs incident light as a color image. The image pickup device 30 may be provided integrally with the microscope 10 or may be provided inside an image pickup apparatus (e.g., digital camera) connectable with the microscope 10.

The image processing apparatus 20 is constituted of, for example, a PC (Personal Computer) and stores an image of the sample SPL generated by the image pickup device 30 as digital image data (virtual slide) of a predetermined format such as JPEG (Joint Photographic Experts Group).

### [Structure of Image Processing Apparatus]

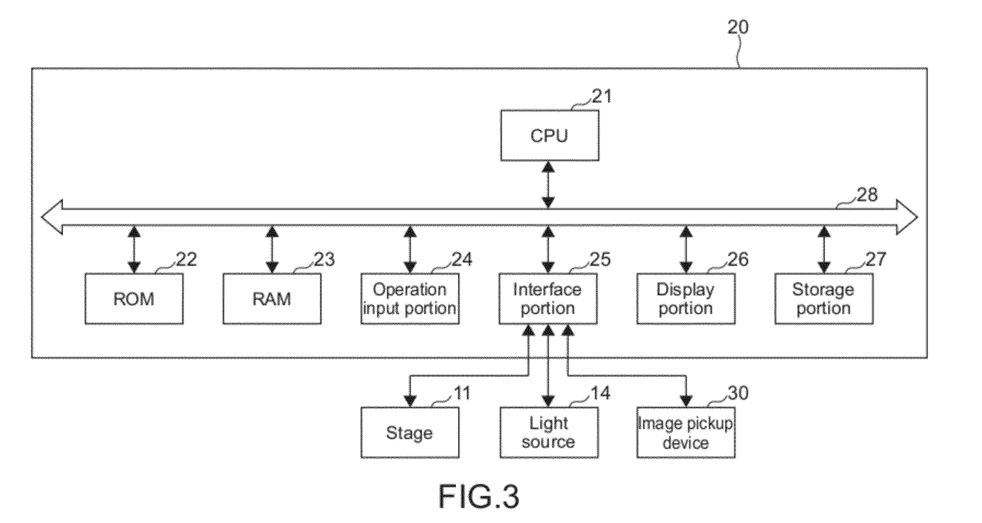

FIG. 3 is a block diagram showing a structure of the image processing apparatus 20.

As shown in the figure, the image processing apparatus 20 includes a CPU (Central Processing Unit) 21, a ROM (Read Only Memory) 22, a RAM (Random Access Memory) 23, an operation input portion 24, an interface portion 25, a display portion 26, and a storage portion 27 that are connected via a bus 28.

The ROM 22 fixedly stores a plurality of programs such as firmware for executing various types of processing and a plurality of types of data. The RAM 23 is used as a working area of the CPU 21 and temporarily stores an OS (Operating System), various applications that are being executed, and various types of data that are being processed.

The storage portion 27 is a nonvolatile memory such as an HDD (Hard Disk Drive), a flash memory, and other solid-state memories. The storage portion 27 stores an OS, various applications, and various types of data. Particularly in this embodiment, the storage portion 27 stores image data that has been taken in from the microscope 10 and an image processing application for processing the image data and calculating a depth of a bright spot of a target in the sample SPL (height in Z-axis direction (optical-axis direction of objective lens 12A)).

The interface portion 25 connects the image processing apparatus 20 to the stage 11, light source 14, and image pickup device 30 of the microscope 10 and exchanges signals with the microscope 10 under a predetermined communication standard.

The CPU 21 develops, in the RAM 23, a program corresponding to a command from the operation input portion 24 out of a plurality of programs stored in the ROM 22 and the storage portion 27 and appropriately controls the display portion 26 and the storage portion 27 according to the developed program. Particularly in this embodiment, the CPU 21 executes calculation processing for a depth of a target in the sample SPL by the image processing application. At this time, the CPU 21 appropriately controls the stage 11, the light source 14, and the image pickup device 30 via the interface portion 25.

A PLD (Programmable Logic Device) such as an FPGA (Field Programmable Gate Array) and other devices such as an ASIC (Application Specific Integrated Circuit) may be realized instead of the CPU 21.

The operation input portion 24 is, for example, a pointing device such as a mouse, a keyboard, a touch panel, or other operation apparatuses.

The display portion 26 may be provided integrally with the image processing apparatus 20 or may be externally connected to the image processing apparatus 20.

### [Operation of Image Processing System]

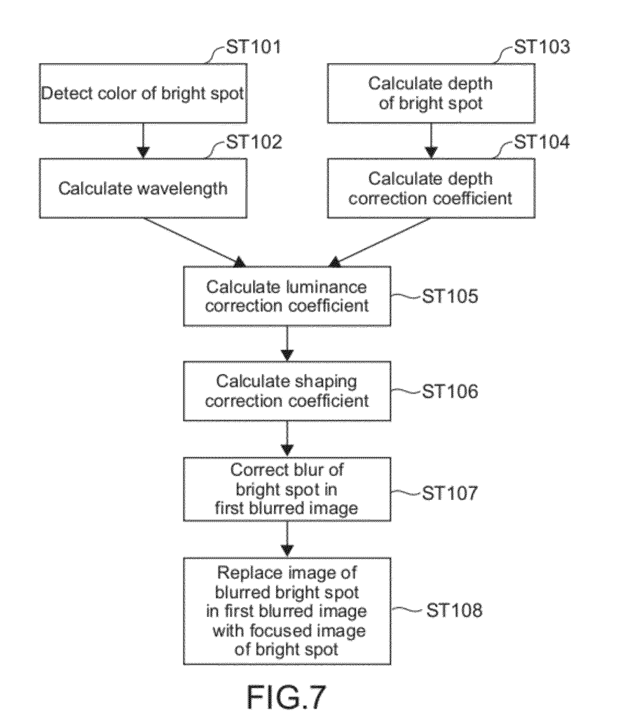

An operation of the microscope 10 structured as described above and processing of the image processing apparatus 20 will be described. FIG. 7 is a flowchart showing the processing of the image processing apparatus 20. The processing of the image processing apparatus 20 is realized by a software program stored in a storage device (ROM 22, storage portion 27, etc.) and a hardware resource such as the CPU 21 cooperating with each other. In descriptions below, a subject of the processing will be the CPU (CPU 21) for convenience.

The sample SPL that has been subjected to fluorescent staining as that shown in FIG. 2, for example, is mounted on the stage 11 of the microscope 10 by a user. The CPU detects a color of a fluorescent marker M that appears as a bright spot in the sample SPL (Step 101) and specifies a wavelength thereof (Step 102). In this case, the CPU functions as a wavelength calculation portion.

In actuality, in Steps 101 and 102, the CPU is capable of acquiring data of a pixel value (luminance value) obtained by the image pickup device 30 and grasping to which fluorescent color (wavelength range) the pixel value belongs by referring to the table shown in FIG. 6. In this case, the CPU may select one of the wavelengths each representing a wavelength range of a fluorescent color.

The CPU may calculate the wavelength by an operation that uses a predetermined algorithm based on the pixel value without using the table shown in FIG. 6.

On the other hand, the CPU calculates a depth of the fluorescent markers M1 and M2 in the optical-axis direction (Z-axis direction) (Step 103). In this case, the CPU mainly functions as a depth calculation portion. Hereinafter, the depth calculation method will be described.

### <Calculation of Depth of Bright Spot>

After the sample SPL is mounted on the stage 11, the CPU sets an initial position of the stage 11 in a vertical direction (Z-axis direction).

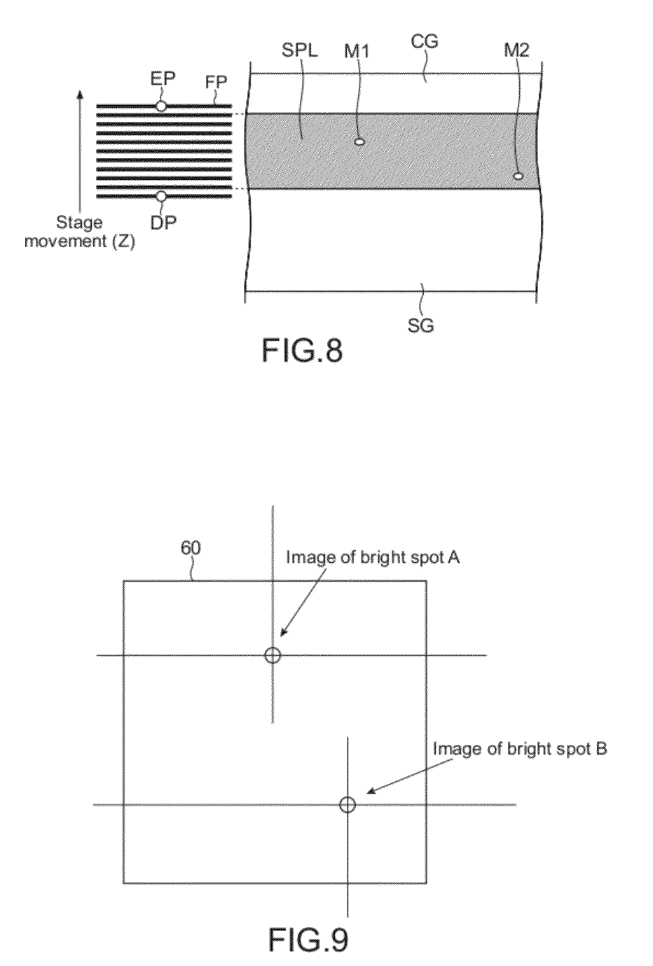

As shown in FIG. 8, an initial position DP (Default position) is set such that a position of a focal point surface FP of the objective lens 12A is located outside (above or below) a range in which the sample SPL is present in the depth direction, that is, a movement range of the focal point (scanning range) becomes the entire surface of the sample SPL in an exposure process of the image pickup device 30.

Subsequently, as indicated by the arrow of FIG. 8, the CPU photographs the sample SPL by an exposure of the image pickup device 30 while moving the stage 11 (i.e., focal point) in the vertical direction (Z-axis direction) from the initial position DP at a predetermined constant velocity. Here, the CPU sets a position at which the scanning range becomes the entire surface of the sample SPL as a movement end position EP (End point). In other words, the initial position DP and the end position EP are set such that the sample SPL fits in the range between the initial position DP and the end position EP (scanning range becomes longer than thickness of sample SPL).

FIG. 9 is a diagram showing an image of the sample SPL obtained by carrying out exposure processing while the focal point is being scanned as described above (first blurred image). As shown in the figure, in a first blurred image 60, the fluorescent marker M1 represents an image of a bright spot A, and the fluorescent marker M2 represents an image of a bright spot B.

Here, since the first blurred image 60 is an image taken by being exposed while the focal point is being scanned in the Z-axis direction of the sample SPL, the first blurred image 60 becomes an image in which an image of the focal point surface FP focused on the fluorescent markers M1 and M2 and an image of the focal point surface FP not focused on the fluorescent markers M1 and M2 are superimposed. Therefore, the images of the bright spots A and B are slightly blurred on the periphery, but the positions thereof are clearly recognizable.

The CPU acquires the first blurred image 60 from the image pickup device 30 via the interface portion 25 and temporarily stores it in the RAM 23.

Subsequently, the CPU sets back the stage 11 in the Z-axis direction at the initial position DP.

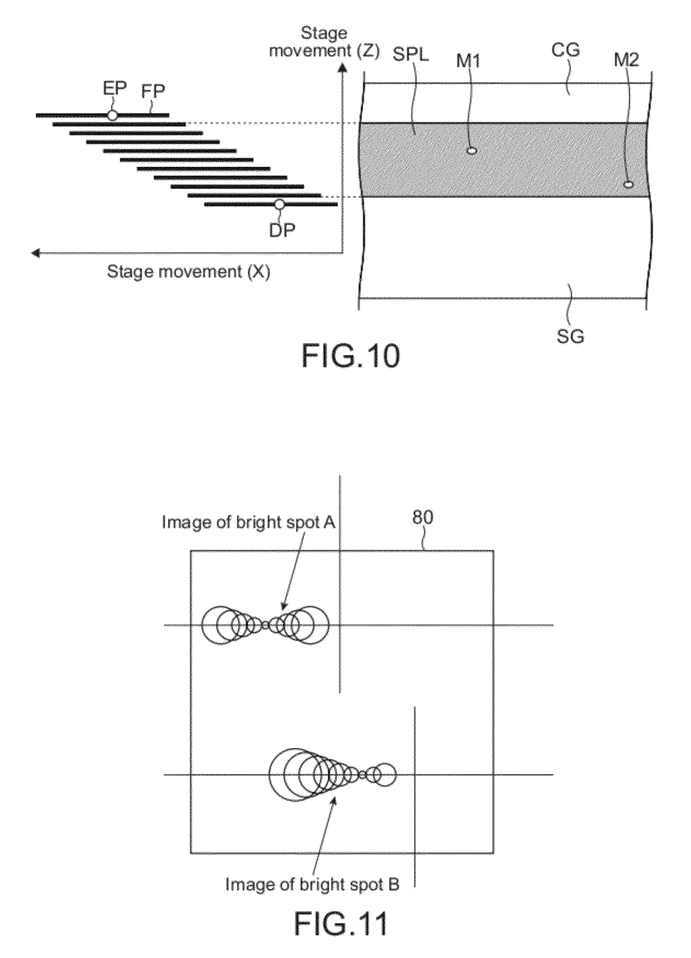

FIG. 10 is a diagram showing a state of a next scan of the focal point in the Z- and X-axis directions.

As shown in FIG. 10, by an exposure of the image pickup device 30 while the CPU moves the stage 11 (focal point) from the initial position DP to the end position EP at a first velocity (V_{z}) in the Z-axis direction and also at a second velocity (Vₓ) in the X-axis direction, the CPU photographs the sample SPL. In other words, the stage 11 moves along a direction that includes a component of the optical-axis direction but is different from the optical-axis direction.

FIG. 11 is a diagram showing an image of the sample SPL obtained by carrying out exposure processing while the focal point is being scanned in the Z- and X-axis directions (second blurred image). As shown in the figure, in a second blurred image 80, a trajectory of an image obtained every time the focal position is changed in the sample SPL appears in a single image. In other words, the images of the bright spots A and B representing the fluorescent markers M1 and M2 change from a large blurred state to a small focused state accompanying scanning of the focal point in the X-axis direction and again change to a blurred state after that.

The CPU acquires the second blurred image 80 from the image pickup device 30 via the interface portion 25 and temporarily stores it in the RAM 23.

Next, the CPU generates a synthetic image by synthesizing the first blurred image 60 and the second blurred image 80.

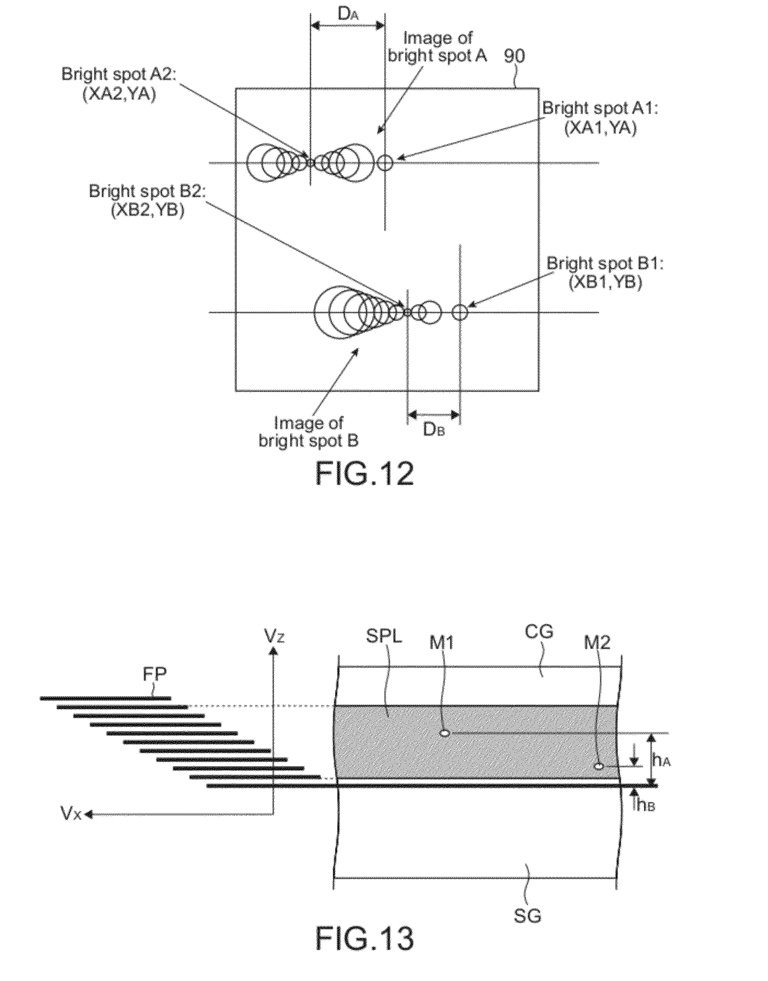

FIG. 12 is a diagram showing the synthetic image. As shown in the figure, in the synthetic image 90, the images of the bright spots A and B that have appeared in the acquired first blurred image 60 (bright spots A1 and B1) and the images of the bright spots A and B that have appeared in the acquired second blurred image 80 (bright spots A2 and B2) respectively appear on the same lines in a single image.

Subsequently, the CPU detects, from the synthetic image 90, positional coordinates of the bright spots A1 and B1 in the first blurred image 60 (A1: (XA1, YA), B1: (XB1, YB)) and positional coordinates of the bright spots A2 and B2 in the second blurred image 80 (A2: (XA2, YA), B2: (XB2, YB)). Here, the CPU detects each of the bright spots by extracting a group of a plurality of pixels having luminance values of a predetermined threshold value or more (fluorescence intensity), for example, and detecting a position of a pixel having a highest luminance. When fluorescent staining of a color that differs depending on a target is performed, the CPU detects the luminance for each of different colors.

Then, the CPU calculates a distance between the detected bright spots (D_{A}, D_{B}) in each of the first blurred image 60 and the second blurred image 80. In other words, in FIG. 12, the CPU calculates a distance D_{A}: (XA1−XA2) between the bright spot A1: (XA1, YA) and the bright spot A2 (XA2, YA) and a distance D_{B}: (XB1−XB2) between the bright spot B1: (XB1, YB) and the bright spot B2 (XB2, YB).

After that, the CPU calculates, based on the distances D, the first velocity V_{z} as a movement velocity of the focal point in the Z-axis direction, and the second velocity Vₓ as a scanning velocity of the focal point in the X-axis direction, a depth h of each fluorescent marker M in the sample SPL.

FIG. 13 is a diagram showing calculation processing for a depth of the fluorescent marker M using the synthetic image 90 shown in FIG. 12. Here, a time t_{A} that elapses before the focal point is focused on the bright spot A since the stage 11 has started moving is calculated by t_{A}=h_{A}/V_{z} (h_{A} represents height of bright spot A in sample SPL).

The distances D_{A} and D_{B} are also expressed by the following expressions.

D_{A}=t_{A}*Vₓ=V_{X}*h_{A}/V_{z}=h_{A}*Vₓ/V_{z}

D_{B}=h_{B}*VₓN_{z}

By deforming the expressions above, the depths h_{A} and h_{B} of the bright spots A and B can be calculated by the following expressions.

h_{A}=D_{A}*V_{z}/Vₓ

h_{B}=D_{B}*V_{z}Nᵥ

The CPU calculates the depths h_{A} and h_{B} of the bright spots A and B based on the expressions above and outputs information obtained by the calculation to, for example, the display portion 26 for each bright spot. By calculating the depth of each bright spot, it becomes possible to judge whether the fluorescent marker M1 represented by the bright spot A and the fluorescent marker M2 represented by the bright spot B exist in the same tissue (cell), for example. It also becomes possible to detect a 3D distance between the fluorescent marker M1 and the fluorescent marker M2. An operator of the image processing system can use the calculation result in, for example, various pathological materials and a research of new drugs.

Here, the second velocity Vₓ is set to be larger than the first velocity V_{z}. This is because, when specifying coordinates of positions at which the images of the bright spots A and B deriving from the second blurred image 80 are focused in the synthetic image 90 (A2 and B2), if an overlapping range of the blurred images is large, the images become difficult to be separated, with the result that the coordinates (A2 and B2) cannot be specified with ease.

Further, as shown in FIG. 13, the depths h_{A} and h_{B} of the bright spots A and B are each calculated as a distance between the initial position DP of the focal point and the bright spot. Therefore, for calculating an accurate height based only on the sample SPL, a length corresponding to a distance between the initial position DP and a boundary between the slide glass SG and the sample SPL only needs to be subtracted from the calculated depths h_{A} and h_{B}.

It should be noted that the CPU is capable of specifying a pixel group constituting an image of a blurred bright spot in the first blurred image 60 based on whether luminance values of obtained pixels exceed a preset threshold value. In other words, the CPU is capable of recognizing that an image of the pixel group in the first blurred image 60 is an image of one blurred bright spot.

The processes of Steps 101 to 103 are not limited to the order described above, and Step 103 may be executed before Steps 101 and 102, for example.

### <Correction of Blurred Image>

Referring to FIG. 7, the CPU corrects a blur of the first blurred image 60 obtained by a scan of the focal point in the Z-axis direction based on the information on the calculated depth of each bright spot (Steps 104 to 108). In this case, the CPU mainly functions as a correction portion.

The CPU calculates a depth correction coefficient (depth correction parameter) for each unit depth (Step 104). The depth correction coefficient is preset to a predetermined value for each unit depth as in a case where, for example, the depth correction coefficient is 0 at a center position in the depth direction, is +1 at a position ±1 μm apart from that position in the depth direction, is +2 at a position ±2 μm apart from that position in the depth direction, and so on. The unit depth is not limited to 1 μm.

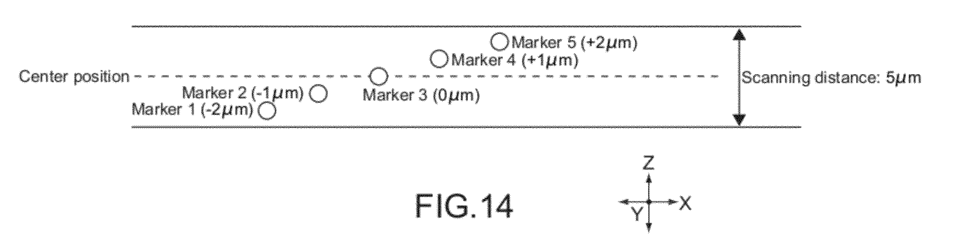

FIG. 14 is a diagram for explaining that a luminance of a bright spot differs for each unit depth.

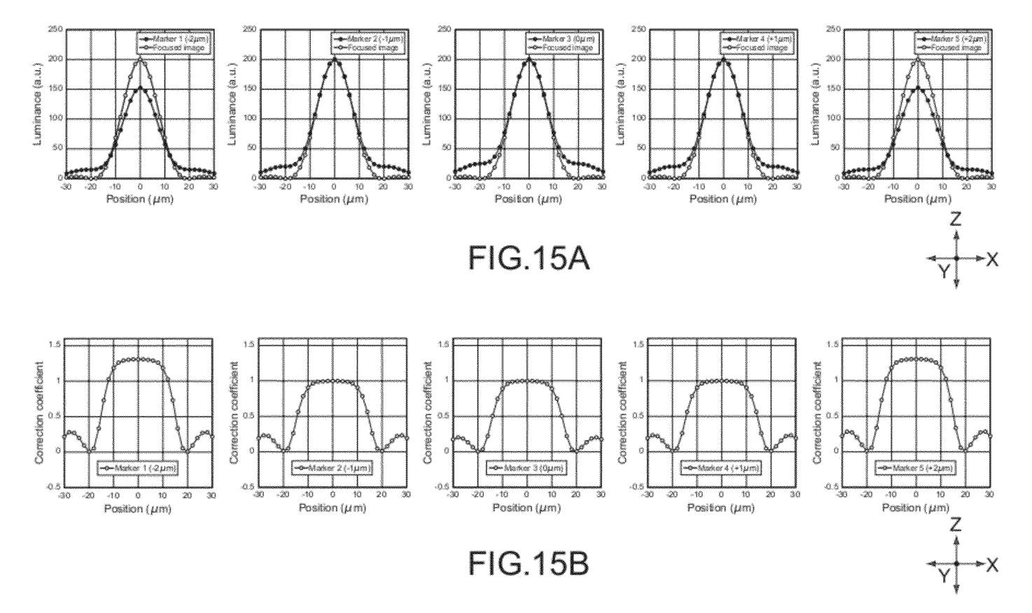

As shown in FIG. 14, when the scanning range of the focal point is, for example, 5 μm, a marker (fluorescent marker) 3 is present at a center position of the scanning range, and markers 1, 2, 4, and 5 are present at respective positions ±1 μm apart from the center position in the depth direction. In this case, as shown in FIG. 15A, the CPU can obtain a luminance distribution (graph indicated by black dots) of each pixel for the bright spots of the markers 1 to 5. Here, it is assumed that the emission colors of the markers 1 to 5 are all the same. In FIG. 15A, the abscissa axis represents an X position (or Y position) (pixel position) of the first blurred image, and the ordinate axis represents a luminance (standard value with luminance peak value being set to 200).

As indicated by the graphs of black dots of FIG. 15A, the bright spots of the markers 2 to 4 each have a highest luminance peak value, and the luminance peak values of the bright spots of those markers become lower as the markers move away from the center position at which the marker 3 is present in the scanning range. It should be noted that although the luminance peak value of the marker 2 is the same as that of the markers 3 and 4 in this example, the luminance peak value of the marker 2 may be higher than that of the markers 3 and 4 in some cases.

As described above, the reason why the luminance values differ according to a difference in the depths at which the bright spots exist in the first blurred image 60 is as follows.

While the focal point is being scanned, that is, during exposure of the image pickup device 30, the marker whose total time the focal point is focused or is in a close state is longest out of the markers 1 to 5 is the marker 3 at the center position. As the total time increases, the luminance peak value of the bright spot increases. As the marker moves away from the center position, the total time thereof in the focused state or a close state becomes shorter, and thus the luminance peak value becomes lower. Therefore, a luminance distribution of the first blurred image 60 obtained by the scan becomes the luminance distribution in the graph of the black dots as shown in FIG. 15A.

It should be noted that although the luminance distribution is obtained 2-dimensionally in the example shown in FIG. 15A, since the image pickup device 30 actually have pixels that are arranged 2-dimensionally in the X- and Y-axis directions, the CPU can obtain a 3D luminance distribution. To help understand the description, the luminance distribution is expressed 2-dimensionally (X-Z in this case) as shown in FIG. 15A.

As described above, since the luminance peak values differ according to a difference in the depths at which the bright spots exist, the CPU generates the depth correction coefficient as described above for quantifying the luminance peak value.

The depth correction coefficient is not limited to the case where it is preset as described above. For example, the CPU may calculate a difference between a highest luminance peak value and a lowest luminance peak value out of luminance peak values of a plurality of bright spots in the first blurred image 60 and calculate a depth correction coefficient for each unit depth based on that difference.

Subsequently, the CPU calculates a luminance correction coefficient (Step 105).

Based on a wavelength of the bright spot (wavelength coefficient) and the depth correction coefficient obtained in Steps 102 and 104 and an NA (Numerical Aperture) of the objective lens 12A, the CPU calculates a luminance correction coefficient (luminance correction parameter) for correcting a luminance of the bright spots A1 and A2 in the first blurred image 60. Data of the calculated wavelength is used for calculating the luminance correction coefficient.

The reason why the data of a wavelength of a bright spot is used is because the focal depth of the objective lens 12A differs depending on a wavelength of a bright spot, and thus a blur degree, that is, a luminance of the bright spot differs. The focal depth d is expressed by d=λ/NA². λ represents a wavelength. For example, when there are presumably two bright spots that have different wavelengths at the same depth, even when the focal point is focused on one of the bright spots, since the other bright spot is not focused and blurred, the luminance of the bright spots differ that much. Therefore, the CPU selects a wavelength coefficient that depends on the wavelength.

As an example, when a wavelength coefficient of a center wavelength between 500 to 550 nm out of a total wavelength range of light is 0, the wavelength coefficient is set such that it increases a predetermined value every time the wavelength changes by an amount corresponding to a unit wavelength range (e.g., 50 nm) with respect to the center wavelength range. The wavelength coefficient only needs to be set to a predetermined value in advance for each unit wavelength.

Then, the CPU calculates the luminance correction coefficient based on the depth correction coefficient and the wavelength coefficient. For example, by multiplying the depth correction coefficient by the wavelength coefficient or by an operation by a predetermined algorithm using the depth correction parameter and the wavelength correction parameter, the CPU calculates the luminance correction coefficient for quantifying the luminance values of the bright spots A1 and A2 of the first blurred image 60. In other words, the CPU calculates the luminance correction coefficient such that the luminance peak values of the bright spots that have the same wavelength range and exist at substantially the same depth are substantially the same.

Subsequently, the CPU calculates a shaping correction coefficient (shaping correction parameter) (Step 106).

The shaping correction coefficient is set according to a distance from a position at which a luminance peak value of a bright spot exists in a plane of the first blurred image 60. In other words, the position at which the luminance peak value of a bright spot exists (hereinafter, referred to as peak position) practically matches a center position of a bright spot in which a blur has occurred.

The shaping correction coefficient may also be preset according to a distance from a peak position. In this case, the shaping correction coefficient may be set for each unit depth. In this case, the shaping correction coefficient is set such that the luminance distributions of the bright spots that have the same wavelength range and exist at substantially the same depth practically match.

Alternatively, since the luminance of the bright spot that is farther away from the peak position out of the bright spots in the first blurred image 60 becomes smaller, the CPU may calculate the shaping correction coefficient based on a change rate of the luminance from the peak position.

It should be noted that in Step 107, as a peak position calculation method, a pixel having a maximum luminance value only needs to be extracted as a peak position out of pixels having luminance values exceeding a preset threshold value in the pixels of the first blurred image 60. The threshold value may be calculated based on a difference between a maximum luminance value and a minimum luminance value in the first blurred image 60.

Next, the CPU uses the calculated luminance correction coefficient and shaping correction coefficient to correct the bright spots A1 and A2 of the first blurred image 60 (Step 107). As a result, a focused image of the bright spots A1 and A2 can be obtained. For example, the CPU can obtain a focused image by repetitively carrying out image fitting by a subtraction.

FIG. 15A is a diagram showing results obtained by correcting a blur of a bright point of each of the markers 1 to 5 in the graph each indicated by the black dots using a correction profile including the luminance correction coefficient and the shaping correction coefficient (FIG. 15B). In FIG. 15B, the abscissa axis represents an X position (or Y position) (pixel position) of the first blurred image that corresponds to FIG. 15A, and the ordinate axis represents the correction coefficient.

As shown in FIG. 15A, a focused image (image in which blur is suppressed) indicated by white dots in FIG. 15A is generated by processing (multiplication in this case) the luminance distribution of the blurred image indicated by the black dots using the correction coefficients shown in FIG. 15B (luminance correction coefficient and shaping correction coefficient).

Then, the CPU partially replaces the blurred image of the bright spots A1 and A2 in the first blurred image 60 with the focused image of the bright spots A1 and A2 obtained by the blur correction (Step 108). As a result, an image including the bright spots A1 and A2 for which the blur has been corrected, that is, the focused bright spots A1 and A2 corresponding to the first blurred image 60 is generated.

As described above, since the depth of the bright spot in the observation area of the sample is calculated based on the first blurred image 60 and the second blurred image 80 in this embodiment, a data amount can be reduced. Specifically, as compared to a case where the stage 11 is moved in step feed in the optical-axis direction and many images are taken for each step feed and stored, in this embodiment, by merely storing two images of the first blurred image 60 and the second blurred image 80, a depth of a bright spot can be calculated. As a result, a data amount can be reduced.

A blur degree of a bright spot in a fluorescent image obtained by the microscope 10 changes depending on a depth of the bright spot in the sample in the optical-axis direction, that is, the focal depth, but in this embodiment, the first blurred image 60 is corrected based on information on the calculated depth of the bright spot in the sample. As a result, the luminance of the bright spot can be quantified.

In this embodiment, the CPU can easily execute a luminance correction operation by correcting a luminance using the depth correction coefficient.

In this embodiment, when the luminance correction coefficient and the shaping correction coefficient are preset, a correction profile for each unit depth (and each wavelength range) as shown in FIG. 15B is stored in advance in a storage device. Then, the CPU only needs to select one correction profile from the correction profiles as appropriate by a look-up table system based on the calculated wavelength and depth of the bright spot and correct a blur of the bright spot in the first blurred image 60.

### [List Data of Focused Image]

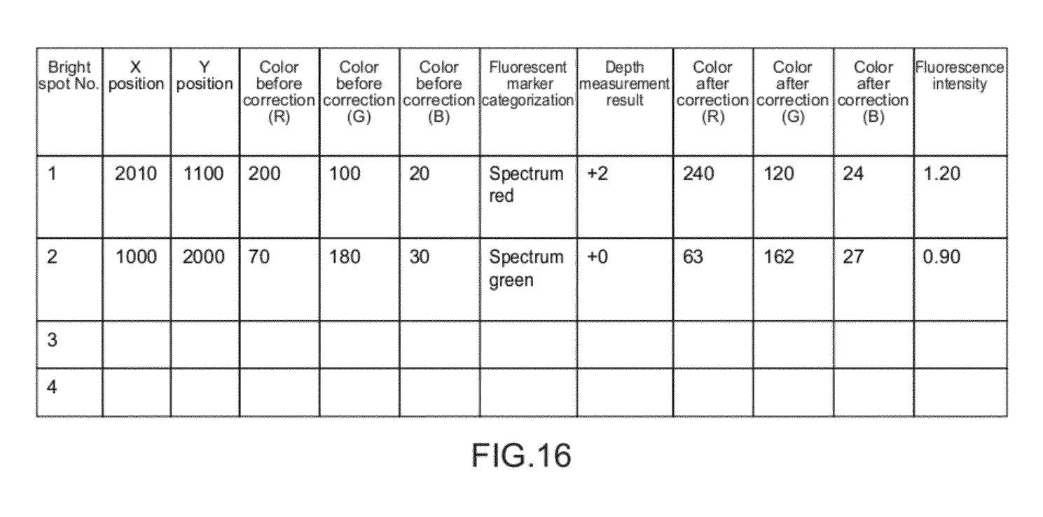

FIG. 16 shows an example of list data of a focused image generated in Step 108.

This example shows a list of two bright spots (bright spot numbers 1 and 2).

XY positions of the bright spots indicate bright spot center pixel positions (of maximum luminance of bright spots).

Colors before and after correction (RGB luminance values) indicate luminance peak values of the bright spots.

A fluorescent marker categorization indicates, as a result of a color detection in Step 101, a type of a fluorescent marker most likely to be that color.

A fluorescence intensity indicates, in a case where a luminance of a bright spot present at a depth of a center position (standard luminance) is set to be 1.00, how many times a luminance of a bright spot present at a depth distant from the center position is with respect to the standard luminance. Therefore, in this example, the RGB luminance values obtained after the correction of the two bright spots are 1.2 and 0.9 times the RGB luminance values obtained before the correction.

### [Method of Creating 3D Image Data]

The CPU is also capable of generating a 3D image after correcting the first blurred image 60. In this case, the CPU mainly functions as a 3D image generation portion.

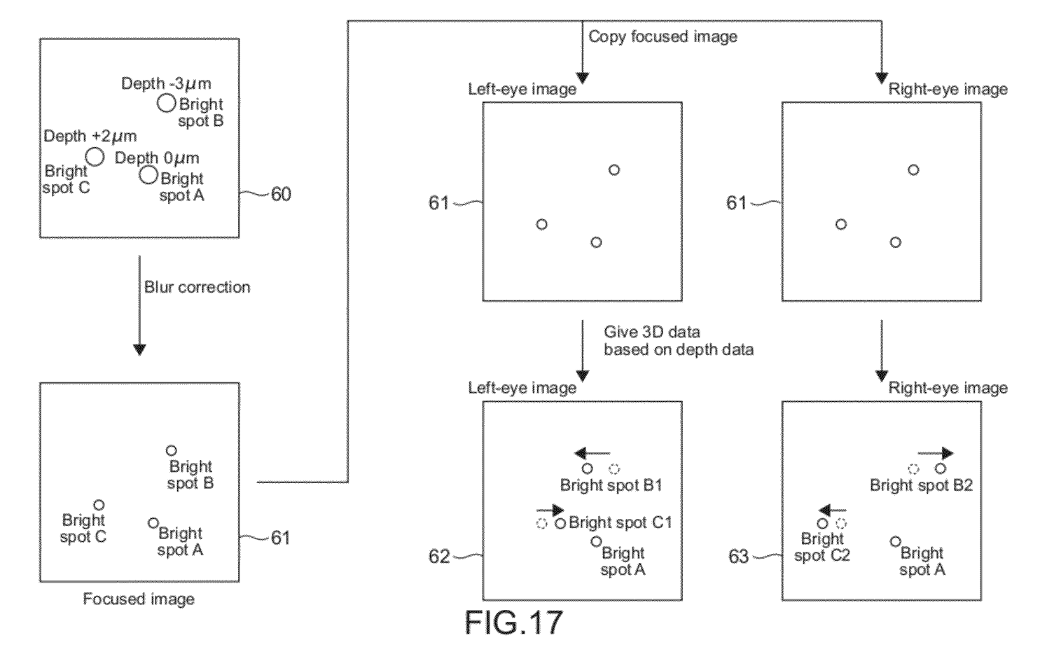

FIG. 17 is a diagram for explaining the method of generating 3D image data. The CPU obtains a focused image 61 by correcting a blur of the bright spots of the first blurred image 60 in Steps 107 and 108 as described above. It should be noted that although two bright spots A1 and A2 have existed in the observation area in the descriptions above, three bright spots A to C whose depths are −3 μm, 0 (center position of scanning range), and +2 μm, respectively, exist in the descriptions herein.

For generating left- and right-eye images, the CPU copies the focused image 61 and generates a left-eye image 62 and a right-eye image 63.

Comparing with the bright spot A (depth 0 μm) as a standard, the bright spot B (−3 μm) distant from the objective lens 12A is corrected as follows. Specifically, for the focused image of the bright spot B, the CPU shifts a left-eye image in the left-hand direction and a right-eye image in the right-hand direction according to a depth from the standard (−3 μm).

On the other hand, comparing with the bright spot A as a standard, the bright spot C (+2 μm) close to the objective lens 12A is corrected as follows. Specifically, for the focused image of the bright spot C, the CPU shifts a left-eye image in the right-hand direction and a right-eye image in the left-hand direction according to a depth from the standard (+2 μm).

A shift amount of the focused images of the bright spots B and C can be set as follows. For example, when the shift amount per unit depth (e.g., 1 μm) in the lateral direction is 10 pixels, the shift amount of the focused image of the bright spot B can be set to be 30 pixels, and the shift amount of the focused image of the bright spot C can be set to be 20 pixels. It should be noted that the position of the bright spot A does not change.

### [Correction of Blurred Image of Target According to Another Embodiment]

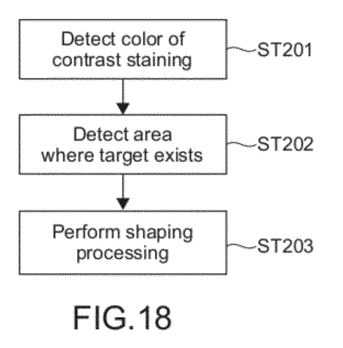

FIG. 18 is a flowchart showing correction processing for a blurred image of a target according to another embodiment of the present disclosure.

In the embodiment above, when fluorescent staining is performed, a polymer such as a DNA and an RNA that has a relatively-high luminance has been the target. In this embodiment, descriptions will be given on a correction of a blurred image of a target that continuously exists in the sample SPL across the entire scanning range of the stage 11 when fluorescent staining is performed. The target in this case is typically a “cell nucleus” including a polymer target such as a DNA and an RNA. In other words, staining in this case typically refers to contrast staining.

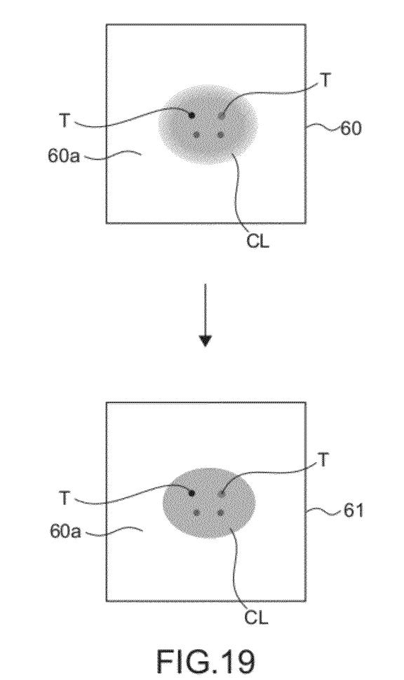

FIG. 19 is a diagram for explaining the correction processing.

In general, a thickness of a cell nucleus CL in the optical-axis direction is sufficiently larger than a thickness of a polymer target T such as a DNA and an RNA in the optical-axis direction. Therefore, by performing contrast staining on the cell nucleus CL, when the stage 11 is scanned in the optical-axis direction, the microscope 10 can obtain an image of the cell nucleus CL with a higher luminance than a luminance of a periphery 60a of the cell nucleus CL across the entire scanning range.

However, when the cell nucleus CL is observed at a magnification used when observing the polymer target T such as a DNA and an RNA (high magnification), the focal point of the objective lens 12A is not at the cell nucleus CL in the scanning range. Therefore, as shown in the upper figure of FIG. 19, the image of the cell nucleus CL obtained in the first blurred image 60 is obtained in a slightly-blurred state at a uniform luminance higher than that of the periphery 60a of the cell nucleus CL, for example. However, the uniform luminance that appears as a stain of the cell nucleus CL becomes lower than that of the bright spot of the polymer target T such as a DNA and an RNA.

The CPU detects an area in which such a cell nucleus CL exists based on the first blurred image 60, for example. In this case, the CPU functions as another correction portion.

As shown in FIG. 18, the CPU detects a fluorescent color of contrast staining (Step 201). This process is the same as that of Step 101 (see FIG. 7).

Then, the CPU detects a boundary between the cell nucleus CL and the periphery 60a thereof (Step 202). An edge detection technique may be used for this area detection. In the edge detection, a pixel area whose luminance gradually decreases or changes to another luminance (pixel area having luminance change rate equal to or larger than threshold value) is detected from pixel positions of the cell nucleus CL having uniform luminance in the first blurred image 60.

Subsequently, the CPU corrects the pixel area by shaping processing (Step 203). By the shaping processing, an image corresponding to the pixel area is replaced with an image 61 that has an emphasized outline of the cell nucleus CL.

For the shaping processing, the same method as that used in the blur correction processing of Step 107 that uses the shaping correction coefficient of Step 106 (see FIG. 7) is used. In this case, a standard position of the luminance value of the cell nucleus CL may be a pixel position having a peak value out of the luminance values of the entire cell nucleus CL in the first blurred image 60 or a pixel position having a luminance peak value in the pixel area having a luminance change rate equal to or larger than the threshold value.

As a result, in the case of a target having a size of a cell nucleus level, a blurred image can be corrected irrespective of the depth information of the target.

### Other Embodiments

The present disclosure is not limited to the embodiments above, and various other embodiments may also be realized.

The image processing apparatus 20 has moved the focal point by moving the stage 11 in the X(Y)-axis direction when acquiring the second blurred image 80. However, a mechanism that moves the image pickup device 30 in the X(Y)-axis direction may be provided in the image processing apparatus 20 so that the focal point is moved by moving the image pickup device 30 instead of the stage 11 using the mechanism. Alternatively, both of the techniques may be used.

A fluorescent microscope has been used in the embodiments above, but a microscope other than the fluorescent microscope may be used. In this case, the target does not need to be fluorescently stained and only needs to be marked by some marking method to be observable as a bright spot.

The microscope and the image processing apparatus have been provided separately in the embodiments above, but they may be provided integrally as a single apparatus.

The image pickup device is not limited to the RGB color filters for 3 colors and may be equipped with color filters for 4 colors or 5 or more colors.

The depths h_{A} and h_{B} have been calculated in the embodiments above, but since the distances D_{A} and D_{B} are values proportional to the depths h_{A} and h_{B}, the distances D_{A} and D_{B} may be handled as standardized depths in the processes of Step 104 and subsequent steps.

It is also possible to combine at least two feature portions out of the feature portions of the embodiments above.

The present disclosure may also take the following structure.

(1) An image processing apparatus, including:

a depth calculation portion configured to calculate, based on a first blurred image of an observation area of at least a part of a sample, that is obtained by relatively moving an objective lens of a microscope and the sample along an optical-axis direction of the objective lens and a second blurred image of the observation area that is obtained by relatively moving the objective lens and the sample along a direction that includes a component of the optical-axis direction but is different from the optical-axis direction, a depth of a bright spot in the sample in the optical-axis direction, the bright spot being obtained by coloring a target included in the observation area; and

a correction portion configured to correct the first blurred image based on information on the calculated depth of the bright spot.

(2) The image processing apparatus according to (1),

in which the correction portion corrects a luminance of the bright spot using a depth correction parameter set for each unit depth in the optical-axis direction.

(3) The image processing apparatus according to (2), further including

a wavelength calculation portion configured to calculate a wavelength range of light at the bright spot,

in which the correction portion further corrects the luminance of the bright spot based on the depth correction parameter and information on the calculated wavelength range.

(4) The image processing apparatus according to any one of (1) to (3),

in which the correction portion corrects a luminance of the bright spot using a shaping correction parameter set according to a distance from a position of a peak value of the luminance of the bright spot in a plane of the first blurred image.

(5) The image processing apparatus according to any one of (1) to (4), further including

a 3D image generation portion configured to generate a 3D image of the observation area including the target based on information on a luminance of the bright spot corrected by the correction portion and information on the depth of the bright spot calculated by the depth calculation portion.

(6) The image processing apparatus according to any one of (1) to (5), further including

another correction portion configured to correct a blurred image of another target in the first blurred image, the another target including the target, being thicker than the target in the optical-axis direction, and continuously existing in the sample across an entire relative movement range of the objective lens and the sample in the optical-axis direction.

(7) An image processing method, including:

calculating, based on a first blurred image of an observation area of at least a part of a sample, that is obtained by relatively moving an objective lens of a microscope and the sample along an optical-axis direction of the objective lens and a second blurred image of the observation area that is obtained by relatively moving the objective lens and the sample along a direction that includes a component of the optical-axis direction but is different from the optical-axis direction, a depth of the sample in the optical-axis direction at a bright spot obtained by coloring a target included in the observation area; and

correcting the first blurred image based on information on the calculated depth of the bright spot.

(8) An image processing program that causes a computer to execute the steps of:

calculating, based on a first blurred image of an observation area of at least a part of a sample, that is obtained by relatively moving an objective lens of a microscope and the sample along an optical-axis direction of the objective lens and a second blurred image of the observation area that is obtained by relatively moving the objective lens and the sample along a direction that includes a component of the optical-axis direction but is different from the optical-axis direction, a depth of the sample in the optical-axis direction at a bright spot obtained by coloring a target included in the observation area; and

correcting the first blurred image based on information on the calculated depth of the bright spot.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An image processing apparatus, comprising:
a depth calculation portion configured to calculate, based on a first blurred image of an observation area of at least a part of a sample, that is obtained by relatively moving an objective lens of a microscope and the sample along an optical-axis direction of the objective lens and a second blurred image of the observation area that is obtained by relatively moving the objective lens and the sample along a direction that includes a component of the optical-axis direction but is different from the optical-axis direction, a depth of a bright spot in the sample in the optical-axis direction, the bright spot being obtained by coloring a target included in the observation area; and
a correction portion configured to correct the first blurred image based on information on the calculated depth of the bright spot.

2. The image processing apparatus according to claim 1,
wherein the correction portion corrects a luminance of the bright spot using a depth correction parameter set for each unit depth in the optical-axis direction.

3. The image processing apparatus according to claim 2, further comprising
a wavelength calculation portion configured to calculate a wavelength range of light at the bright spot,
wherein the correction portion further corrects the luminance of the bright spot based on the depth correction parameter and information on the calculated wavelength range.

4. The image processing apparatus according to claim 1,
wherein the correction portion corrects a luminance of the bright spot using a shaping correction parameter set according to a distance from a position of a peak value of the luminance of the bright spot in a plane of the first blurred image.

5. The image processing apparatus according to claim 1, further comprising
a 3D image generation portion configured to generate a 3D image of the observation area including the target based on information on a luminance of the bright spot corrected by the correction portion and information on the depth of the bright spot calculated by the depth calculation portion.

6. The image processing apparatus according to claim 1, further comprising
another correction portion configured to correct a blurred image of another target in the first blurred image, the another target including the target, being thicker than the target in the optical-axis direction, and continuously existing in the sample across an entire relative movement range of the objective lens and the sample in the optical-axis direction.

7. An image processing method, comprising:
calculating, based on a first blurred image of an observation area of at least a part of a sample, that is obtained by relatively moving an objective lens of a microscope and the sample along an optical-axis direction of the objective lens and a second blurred image of the observation area that is obtained by relatively moving the objective lens and the sample along a direction that includes a component of the optical-axis direction but is different from the optical-axis direction, a depth of a bright spot in the sample in the optical-axis direction, the bright spot being obtained by coloring a target included in the observation area; and
correcting the first blurred image based on information on the calculated depth of the bright spot.

8. An image processing program that causes a computer to execute the steps of:
calculating, based on a first blurred image of an observation area of at least a part of a sample, that is obtained by relatively moving an objective lens of a microscope and the sample along an optical-axis direction of the objective lens and a second blurred image of the observation area that is obtained by relatively moving the objective lens and the sample along a direction that includes a component of the optical-axis direction but is different from the optical-axis direction, a depth of a bright spot in the sample in the optical-axis direction, the bright spot being obtained by coloring a target included in the observation area; and
correcting the first blurred image based on information on the calculated depth of the bright spot.
